(19) United States
(12) Patent Application Publication
(10) Pub. No.: US 2016/0381659 A1
(43) Pub. Date: Dec. 29, 2016

(54) Systems and Methods for Alert Notifications for Mobile Communication Devices

(71) Applicant: OsMac, LLC, Huntsville, AL (US)

(72) Inventors: Everett W. Osborne, Huntsville, AL (US); Michael McCraw, Huntsville, AL (US)

(21) Appl. No.: 15/191,298

(22) Filed: Jun. 23, 2016

Related U.S. Application Data
(60) Provisional application No. 62/183,574, filed on Jun. 23, 2015.

(51) Int. Cl. H04W 68/00; H04W 4/14

(52) U.S. Cl. CPC H04W 68/005; H04W 4/14

(57) ABSTRACT

An alert notification system of the present disclosure has an originator device configured for transmitting a message and a recipient device for receiving the message. Additionally, the alert notification system has a processor that determines when the message is urgent and generates a notification when the processor determines that the message is urgent. Further, the processor randomly generates a code and displays the generated code to a user. The processor also receives a code input from the user, compares the code input from the user to the generated code, and disables the notification when the code input from the user is the generated code.

### CROSS REFERENCE TO RELATED APPLICATION

This nonprovisional application claims priority to U.S. Provisional Application Ser. No. 62/183,574 entitled Method for Alert Notification for Mobile Communication Devices and filed on Jun. 23, 2015, which is incorporated herein by reference.

### BACKGROUND OF THE INVENTION

Individuals use mobile devices to communicate in various ways. In this regard, users of mobile devices may use text messaging or instant messaging (iMessaging or iMessage), often referred to as texting, to communicate with other individuals. In this particular example, a user of a mobile device drafts a message to an individual or entity. Once the message is drafted, the user selects a “send” pushbutton. Upon selection of the “send” pushbutton, control logic on the mobile device transmits the message to the intended recipient.

Note that there is a slight difference between the iMessage and the traditional text message. This difference merely lies in the way in which the message is transmitted by the control logic. In regards to an iMessage, the control logic transmits the data indicative of the message using the mobile device's WiFi or the user's data connection (3G/4G). In regards to text messaging, the control logic transmits data indicative of the messages through cellular towers in the same way that phone calls are effectuated.

Additionally, individuals may use their mobile devices to draft and send emails, e.g., yahoo mail, outlook, or the like. Most often, the user employs a third-party email application (often call and “app”) in order to have email functionality on their phones.

Traditionally, mobile devices, as described above, have settings for notifications. For example, a user of the mobile device may elect to receive a notification that an iMessage or text message has been received by the mobile device. Sometimes, this notification is a sound, a vibration, or a textual display pop up. They may also elect to receive notifications that an email has been received as well. This characteristic of mobile phones is governed by user settings on the mobile device.

### SUMMARY OF THE INVENTION

An alert notification system of the present disclosure has an originator device configured for transmitting a message and a recipient device for receiving the message. Additionally, the alert notification system has a processor that determines when the message is urgent and generates a notification when the processor determines that the message is urgent. Further, the processor randomly generates a code and displays the generated code to a user. The processor also receives a code input from the user, compares the code input from the user to the generated code, and disables the notification when the code input from the user is the generated code.

A method in accordance with an embodiment of the present disclosure can be generally conceptualized by the following steps: (1) transmitting a message by an originator device; (2) receiving the message by a recipient device; (3) determining, by a processor, when the message is urgent; (4) generating, by the processor, a notification when the processor determines that the message is urgent; (5) for randomly generating, by the processor, a code; (6) displaying, by the processor, the generated code to a user; (7) receiving a code input from the user; (8) comparing the code input from the user to the generated code; and (9) disabling the notification when the code input from the user is the generated code.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure.

FIG. 1 is a block diagram of an exemplary alert notification system in accordance with an embodiment of the present disclosure.

FIG. 2 is a block diagram of an exemplary recipient mobile device of the alert notification system such as is depicted in FIG. 1.

FIG. 3 is a block diagram of an originator mobile device of the alert notification system such as is depicted in FIG. 1.

FIG. 4 is a flowchart describing the architecture and functionality of the alert notification system such as is depicted in FIG. 1.

### DETAILED DESCRIPTION

The present disclosure is directed to mobile device. In particularly, a mobile device in accordance with an embodiment of the present disclosure comprises control logic that intersects messages, e.g., iMessage, text, or email. Searches the data indicative of the message to determine if the message is marked “urgent.” If the message is marked “urgent,” the control logic overrides the user settings and notifies the user of receipt of the message. Additionally, the control logic generates a random code, which the control logic displays to the user. After display of the random code, the control logic displays a user interface requesting that the code provided be entered into the mobile device, e.g., via a user interface with a text box. The control logic compares the code entered with the random code that was displayed previously, and if the code entered is the code displayed, the control disables the alert notification and displays the data indicative of the message received that is marked as urgent. Note that the notification will continue until the correct code is entered.

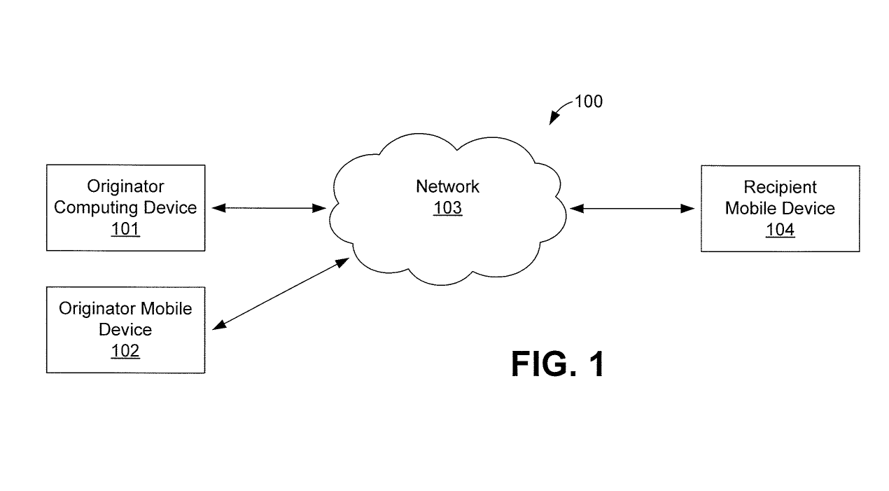

FIG. 1 is a block diagram of an alert notification system 100 in accordance with an embodiment of the present disclosure. The alert notification system 100 comprises a recipient mobile device 104 and an originator computing device 101. The recipient mobile device 104 is configured to receive messages from the originator computing device 101 or the originator mobile device 102 via the network 103.

The recipient mobile device 104 may be any type of wireless device, e.g., smart phone, tablet, or the like, known in the art or future-developed. Thus, the recipient mobile device 104 is capable of receiving and transmitting messages via the network using WiFi or cellular communications.

The originator mobile device 102 may be any type of wireless device, e.g., smart phone, tablet, or the like, known in the art or future-developed. Thus, the originator mobile device 102 is configured to receive messages from and transmit messages to the recipient mobile device 104 via the network 103 using WiFi or cellular communications.

In one embodiment, the system 100 includes the originator computing device 100. The originator computing device 100 may be, for example, a laptop, personal computer, or the like. The originator computing device 101 is configured to receive messages from and transmit messages to the recipient mobile device 104 via the network 103.

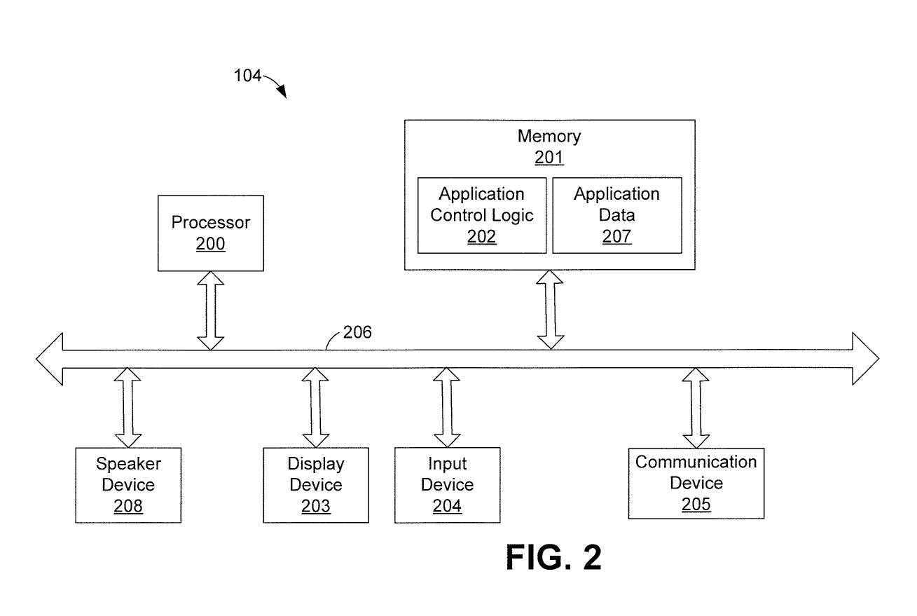

FIG. 2 depicts an exemplary recipient mobile device 104 in accordance with an embodiment of the present disclosure. The exemplary recipient mobile device 104 comprises a processor 200, a display device 203, an input device 204, a speaker device 208, and a communication device 205. Each of these components communicates over local interface 202, which can include one or more buses.

Recipient mobile device 104 further comprises application control logic 202 and application data 207. Application control logic 204 can be software, hardware, or a combination thereof. In the exemplary recipient mobile device 104 shown in FIG. 2, application control logic 202 is shown as software stored in memory 201. Memory 201 may be of any type of memory known in the art, including, but not limited to random access memory (RAM), read-only memory (ROM), flash memory, and the like.

As noted hereinabove, application control logic 202 is shown in FIG. 2 as software stored in memory 201. When stored in memory 201, the application control logic 204 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium

Processor 200 may be a digital processor or other type of circuitry configured to run the application control logic 202 by processing and executing the instructions of the application control logic 202. By way of example, the processor 200 may be an A4 processor, a dual core A5 processor, an A6 chip 62-bit A7 chip, an M7 motion coprocessor, an A8 chip, or an A9 processor. Not that the listed examples are those processors used in the various generations of the iPhone™. Note that other processors may be employed in other types of smart devices in other embodiments. The processor 200 communicates to and drives the other elements within the recipient mobile device 104 via the local interface 206.

The display device 203 is a device for visually communicating information to the user (not shown) of the recipient mobile device 104. The display device 203 may be, for example, a backlit liquid crystal display (LCD) screen (not shown), which is touch-sensitive for operation with a stylus (not shown). Other types of display devices may be used in other embodiments of the present disclosure.

The input device 204 enables the user 110 to enter data into the recipient mobile device 104. In one embodiment, the input device 204 is a virtual keyboard that the application control logic 202 displays allowing the user to enter words, numbers, characters, emoticons, and the like. The user 110 uses the virtual keyboard to type data into the recipient mobile device 104. In addition, the display device 203 may be a touch screen (not shown), and the recipient mobile device 104 may comprise a stylus (now shown) that the user 110 can used to enter data via the touch screen (not shown).

Application data 207 includes any data stored on the recipient mobile device 104 related to the alert notification system 100 (FIG. 1). Such data may comprise a plurality of data fields that when data in one of the data fields is found in the message, the application control logic 202 may originate an alert. As an example, the application data 207 may include data indicative of a plurality of senders, wherein the data indicative of the plurality of senders is entered by the user of the recipient mobile device 104. These senders may be indicated by the user in the application data 207 such that if a message is received from any one of the senders on the list, the message is marked urgent. Not only can the user mark senders as urgent, the user may indicate other data that could be marked urgent. In this regard, the user may provide data indicative of particular subject lines that the user desires to be marked urgent or a date that the user desires to be marked urgent. Notably, any type of data field in a particular message may be associated with an urgent indicator in other embodiments of the present disclosure.

In one embodiment, the controller 102 may comprise a speaker device 208. In such an embodiment, the recipient mobile device 104 may audibly communicate a sound, word, phrase, song or the like to indicate that an urgent message has been received.

The communication device 205 is any type of communication device known in the art or future-developed that enables the recipient mobile device 104 to communicate with the network, the originator mobile device 102, and the originator computing device 101. The communication device 205 may be, for example a WiFi transceiver, an antenna, or the like.

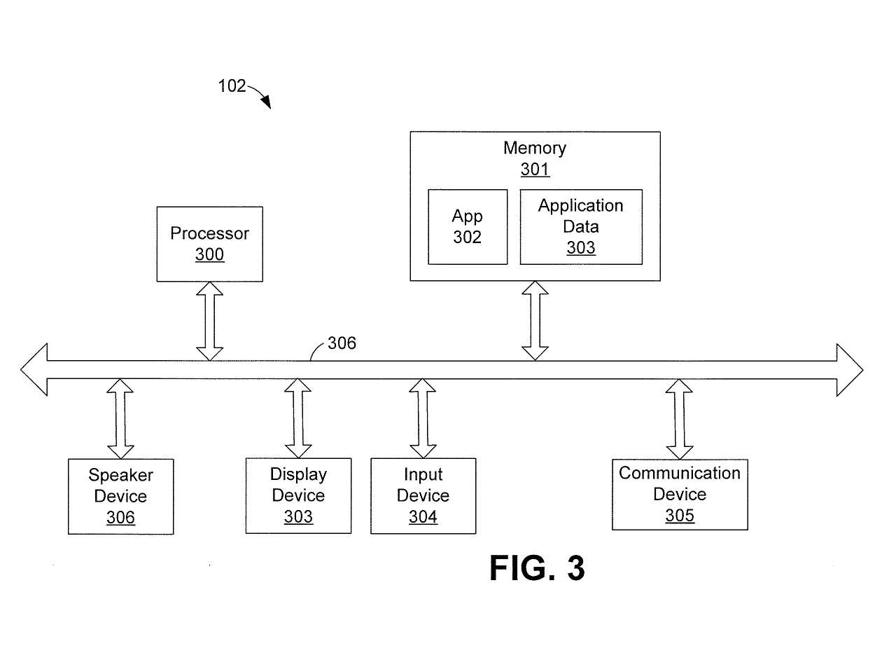

FIG. 3 depicts an exemplary originator mobile device 102 in accordance with an embodiment of the present disclosure. The exemplary originator mobile device 102 comprises a processor 300, a display device 303, an input device 304, a speaker device 308, and a communication device 305. Each of these components communicates over local interface 306, which can include one or more buses.

Originator mobile device 102 further comprises application control logic 302 and application data 307. Application control logic 302 can be software, hardware, or a combination thereof. In the exemplary originator mobile device 102 shown in FIG. 3, application control logic 302 is shown as software stored in memory 301. Memory 301 may be of any type of memory known in the art, including, but not limited to random access memory (RAM), read-only memory (ROM), flash memory, and the like.

As noted hereinabove, application control logic 302 is shown in FIG. 2 as software stored in memory 201. When stored in memory 201, the application control logic 204 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium

Processor 300 may be a digital processor or other type of circuitry configured to run the application control logic 302 by processing and executing the instructions of the application control logic 302. By way of example, the processor 300 may be an A4 processor, a dual core A5 processor, an A6 chip 62-bit A7 chip, an M7 motion coprocessor, an A8 chip, or an A9 processor. Not that the listed examples are those processors used in the various generations of the iPhone™. Note that other processors may be employed in other types of smart devices in other embodiments. The processor 300 communicates to and drives the other elements within the originator mobile device 102 via the local interface 306.

The display device 303 is a device for visually communicating information to the user (not shown) of the recipient mobile device 104. The display device 303 may be, for example, a backlit liquid crystal display (LCD) screen (not shown), which is touch-sensitive for operation with a stylus (not shown). Other types of display devices may be used in other embodiments of the present disclosure.

The input device 304 enables the user to enter data into the originator mobile device 102. In one embodiment, the input device 304 is a virtual keyboard that the application control logic 302 displays allowing the user to enter words, numbers, characters, emoticons, and the like. The user uses the virtual keyboard to type data into the originator mobile device 102. In addition, the display device 303 may be a touch screen (not shown), and the originator mobile device 102 may comprise a stylus (now shown) that the user can used to enter data via the touch screen (not shown).

Application data 207 includes any data stored on the originator mobile device 102 related to the alert notification system 100 (FIG. 1). As an example, the application data 307 may include data indicative of a plurality of senders, wherein the data indicative of the plurality of recipients is entered by the user of the originator mobile device 102. These recipients may be indicated by the user in the application data 307 such that if a message is transmitted to any one of the recipients on the list, the message is marked urgent. Not only can the user mark recipients as urgent, the user may indicate other data that could be marked urgent. In this regard, the user may provide data indicative of particular subject lines that the user desires to be marked urgent. Notably, any type of data field in a particular message may be associated with an urgent indicator in other embodiments of the present disclosure.

In one embodiment, the originator mobile device 102 may comprise a speaker device 308. In such an embodiment, the originator mobile device 102 may audibly communicate a sound, word, phrase, song or the like to indicate that an urgent message has been received.

The communication device 305 is any type of communication device known in the art or future-developed that enables the originator mobile device 102 to communicate with the network and the recipient mobile device 104. The communication device 205 may be, for example, a WiFi transceiver, an antenna, or the like.

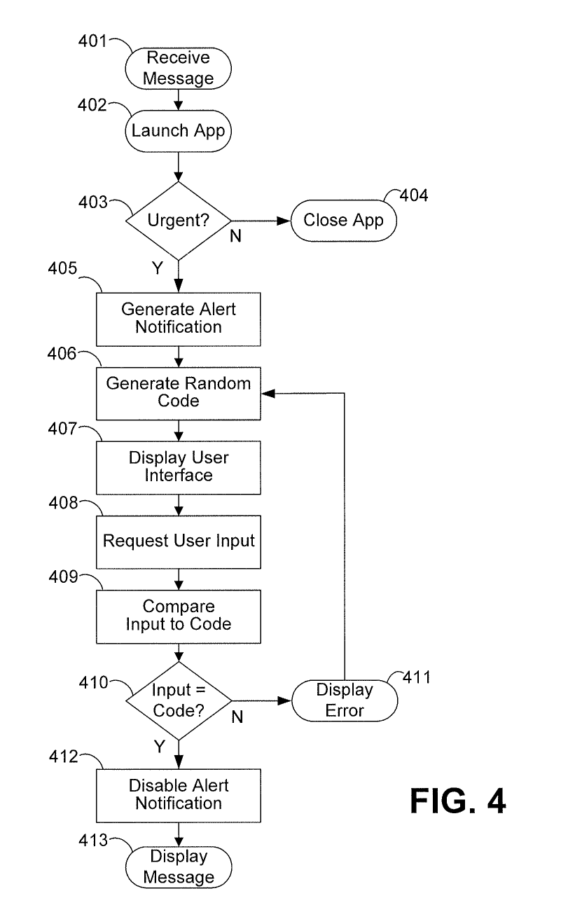

FIG. 4 is a flowchart depicting exemplary architecture and functionality of the application control logic 202. Note that the application control logic 302 may be similarly configured to behave like the application control logic 202.

In step 401, the recipient mobile device 104 receives a message from the originator mobile device 102 via the network 103. Note the message received may be an iMessage, a text message, an email, or the like. Further note that depending upon the type of message, the message may be sent via a cellular network or a WiFi network.

Upon receipt of a message, the recipient mobile device 104 launches the application control logic 202, as indicated in step 402. When the recipient mobile device 104 launches the application control logic 202, the application control logic 202 determines whether the message received is an urgent message.

Note that the user of the originator mobile device 102 may mark the message as urgent prior to sending the message to the recipient mobile device 104. In another embodiment, the application data 207 may comprise a list of senders that, upon receipt from one of the senders listed, the application control logic 202 marks the message as urgent.

In determining from the message whether the message is urgent, the application control logic 202 may search the data indicative of the message received for terms that indicate the message is urgent. For example, there may be a flag set in the data that indicates urgency of the message. In the example provided above, the sender data may indicate that the message is to be considered urgent. Note that the user may configure the system to associate urgency with a message based on any field in the data, e.g., the subject line, the date, or the like.

If the message received is not marked as urgent, the application control logic 202 closes. However, if the message is marked urgent, the application control logic 202 generates an alert notification. The alert may take numerous forms. For example, it may be an audible sound, word, phrase, or song. As will be described further, the notification continues until the user of the recipient mobile device 104 responds to the application control logic 202.

Once the application control logic 202 generates the alert notification, the application control logic 202 generates a random code in step 406. The method for generating the random code may be hardware random number generators, pseudorandom number generators, or the like.

In step 407, the application control logic 202 displays the randomly generated code to the user of the recipient mobile device 104. Additionally, the display requests the user to enter the displayed code in a text box, for example, in step 408.

In step 409, the application control logic 202 compares the input provided by the user with the randomly generated code. If the correct code is not entered, the application control logic 202 displays an error at step 411 and generates a new random code at step 406.

If the input provided by the user matches the randomly generated code, the application disables the alert notification in step 412. In this regard, the audible sound, vibration, or the like, is discontinued. In addition, the application control logic 202 displays the received message.

As described above and shown in the associated drawings, the present disclosure comprises alert notification systems and methods for using the same. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. An alert notification system, comprising:
an originator device configured for transmitting a message;
a recipient device configured for receiving the message; and
a processor configured for determining when the message is urgent and generating a notification when the processor determines that the message is urgent, the processor further configured for randomly generating a code and displaying the generated code to a user, the processor further configured for receiving a code input from the user, comparing the code input from the user to the generated code, and disabling the notification when the code input from the user is the generated code.

2. The alert notification system, wherein the recipient device is a mobile device.

3. The alert notification system, wherein the originating device is a mobile device.

4. The alert notification system 1, wherein the originating device is a computing device.

5. The alert notification system of claim 1, wherein the processor is configured for launching the system upon receipt of a message.

6. The alert notification system of claim 1, wherein the message is a text message.

7. The alert notification system of claim 1, wherein the message is an email.

8. The alert notification system of claim 1, wherein the message is an iMessage.

9. The alert notification system of claim 1, wherein the processor is configured for determining when the message is urgent by searching the message for data indicating that the message is urgent.

10. The alert notification system of claim 1, further comprising application data indicative of data that when found in the message indicates the message is urgent.

11. The alert notification system of claim 10, wherein the application data comprises one or more senders.

12. The alert notification system of claim 10, wherein the application data comprises one or more subject lines.

13. The alert notification system of claim 1, wherein the notification is an audible sound that does not cut off until the user enters the input code that matches the generated code.

14. The alert notification system of claim 1, wherein the notification is a display and when the input code is the generated code, the processor closes the display.

15. The alert notification system of claim 1, wherein the processor displays the message to the user when the input code is generated code.

16. An alert notification method, comprising:
transmitting a message by an originator device;
receiving the message by a recipient device;
determining, by a processor, when the message is urgent;
generating, by the processor, a notification when the processor determines that the message is urgent;
for randomly generating, by the processor, a code;
displaying, by the processor, the generated code to a user;
receiving a code input from the user;
comparing the code input from the user to the generated code; and
disabling the notification when the code input from the user is the generated code.

17. The alert notification method of claim 16, wherein the transmitting is performed by a mobile device.

18. The alert notification method 16, wherein the receiving is performed by a mobile device.

19. The alert notification method 16, wherein the originating is performed by a computing device.

20. The alert notification method of claim 16, further comprising launching the system, by the processor, upon receipt of a message.

21. The alert notification method of claim 16, wherein the transmitting comprises transmitting a text message.

22. The alert notification method of claim 16, wherein the transmitting comprises transmitting an email.

23. The alert notification method of claim 16, wherein the transmitting comprises transmitting an iMessage.

24. The alert notification method of claim 16, further comprising determining, by a processor, when the message is urgent by searching the message for data indicating that the message is urgent.

25. The alert notification method of claim 16, wherein in the determining whether the message is urgent, searching for data within the message to determine when the message is urgent.

26. The alert notification method of claim 25, wherein the searching the data comprises searching for a sender.

27. The alert notification method of claim 25, wherein the application data comprises one or more subject lines.

28. The alert notification method of claim 16, wherein the generating the notification comprising generating an audible sound that does not cut off until the user enters the generated code.

29. The alert notification method of claim 16, wherein the notification comprises:
notifying via a display; and
when the input code is the generated code, closing the display, by the processor.

30. The alert notification system of claim 16, further comprising displaying the message to the user, by the processor, when the input code is generated code.
